(19) United States
(12) Patent Application Publication
(10) Pub. No.: US 2018/0322256 A1
(43) Pub. Date: Nov. 8, 2018

(54) Cirrhosis Forecasting In Human Subjects

(71) Applicant: Pinscriptive, Inc., San Juan Capistrano, CA (US)

(72) Inventors: Roni H. Amiel, Sparta, NJ (US); Fuad Rahman, Santa Clara, CA (US)

(73) Assignee: PINSCRIPTIVE, INC.

(21) Appl. No.: 15/587,245

(22) Filed: May 4, 2017

(51) Int. Cl. G06F 19/00; G06N 99/00; G06N 5/04

(52) U.S. Cl. CPC G06F 19/3437; G06N 5/04; G06N 99/005

(57) ABSTRACT

A system for training a cirrhosis forecast model includes a computing platform having a hardware processor and a memory storing a software code for training the cirrhosis forecast model. The hardware processor executes the software code to receive medical data for each of multiple human subjects, assign a subset of the human subjects as a training group for the cirrhosis forecast model, and identify cirrhosis predictive parameters from the medical data for the training group. The hardware processor also executes the software code to generate a cirrhosis forecast model including a weighted combination of the cirrhosis predictive parameters, produce, using the cirrhosis forecast model, a cirrhosis prediction for at least one of the human subjects omitted from the training group, determine an accuracy of the cirrhosis prediction, and adapt the cirrhosis forecast model based on the accuracy of the cirrhosis prediction.

### BACKGROUND

Advances in pharmaceutical research have resulted in the availability of specialty drugs that give new hope to many patients who previously had lacked effective treatment options. However, many of these drugs are extremely costly, and leave insurers and other entities responsible for paying for patient care in the unenviable position of facing unsustainable costs, or denying access to powerful and beneficial treatments.

For example, specialty pharmaceutical drugs for use in the treatment of hepatitis C may cost from approximately ten thousand to approximately one hundred thousand dollars for a full course of treatment. Despite their nearly prohibitive costs, however, these specialty drugs can be life saving for some patients. As a result techniques for identifying those patients who may be at the greatest risk of developing advanced liver disease can help to enable access to specialty drug treatment by those most in need.

### SUMMARY

There are provided systems and methods for cirrhosis forecasting in human subjects, substantially as shown in and/or described in connection with at least one of the figures, and as set forth more completely in the claims.

### BRIEF DESCRIPTION OF THE DRAWINGS

FIG. 1 shows a diagram of an exemplary system for training a cirrhosis forecast model, according to one implementation;

FIG. 2 shows another exemplary implementation of a system for training a cirrhosis forecast model;

FIG. 3 shows an exemplary system and a computer-readable non-transitory medium including instructions for training a cirrhosis forecast model; and

FIG. 4 is a flowchart presenting an exemplary method for training a cirrhosis forecast model.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As noted above, specialty pharmaceutical drugs for use in the treatment of hepatitis C may cost from approximately ten thousand to approximately one hundred thousand dollars for a full course of treatment. However, and despite their nearly prohibitive costs, these specialty drugs can be life saving for the most vulnerable patients. As a result, techniques for identifying those patients who may be at the greatest risk of developing advanced liver disease can help to enable access to specialty drug treatment by those most in need.

The presence of cirrhosis in a patient having hepatitis C, for example, can foreshadow or accompany progression to advanced liver disease. The present application addresses the serious financial and ethical dilemmas posed by decisions to permit or deny patient access to extremely costly but highly therapeutic specialty drug treatments for hepatitis C by providing systems and methods for training a cirrhosis forecast model. According to various implementations, such a system and method may be used to forecast the likelihood that a patient diagnosed with hepatitis C will subsequently develop cirrhosis, and is thereby likely to progress to advanced liver disease, perhaps requiring liver transplant. Consequently, the systems and methods disclosed in the present application provide powerful tools for identify those patients who might benefit most from specialty drug treatment.

By way of definitions, it is noted that for the purposes of the present application, a “biologic” or “biological medical product” is any pharmaceutical drug manufactured in, extracted from, or at least partially synthesized from biological sources, in contrast to traditional pharmaceutical drugs that are chemically synthesized. In addition, as used herein, a “specialty drug” is a costly prescription medication, which may be chemically synthesized or produced as a biologic, and is used to treat complex, chronic conditions such as hepatitis C, cancer, multiple sclerosis, and rheumatoid arthritis, for example.

It is further noted that, as used in the present application, the term “subject” refers to a human subject, such as a human patient receiving medical evaluation and/or treatment. Moreover, as used herein, the terms “cirrhosis,” “cirrhotic,” and the like, refer specifically to fibrosis of the liver, commonly referred to as cirrhosis of the liver in human subjects.

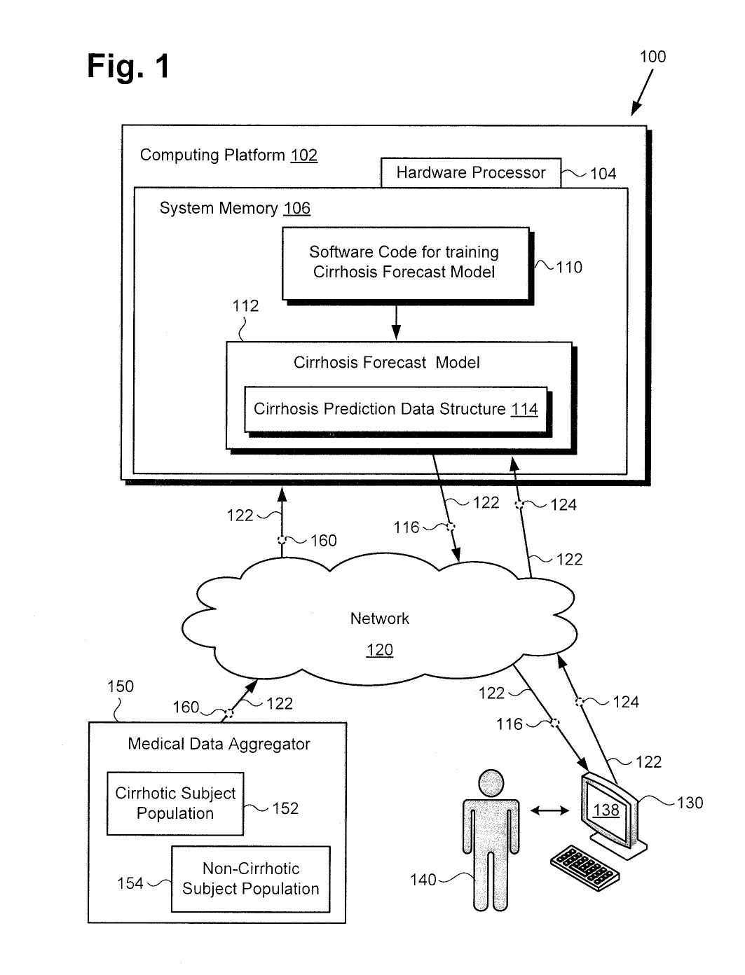

FIG. 1 shows a diagram of an exemplary system for training a cirrhosis forecast model, according to one implementation. System 100 includes computing platform 102 having hardware processor 104 and system memory 106 storing software code 110 for training cirrhosis forecast model 112. It is noted that, in some implementations, in addition to training cirrhosis forecast model 112, software code 110 may also generate cirrhosis forecast model 112.

As shown in FIG. 1, cirrhosis forecast model 112 includes cirrhosis prediction data structure 114. As further shown in FIG. 1, system 100 is implemented within a use environment including communication network 120, client system 130 having display 138, system user 140, and medical data aggregator 150 providing medical data for cirrhotic subject population 152 and non-cirrhotic subject population 154. Also shown in FIG. 1 are network communication links 122 interactively connecting computing platform 102 with client system 130 and medical data aggregator 150, medical data 160 provided by medical data aggregator 150, cirrhosis prediction 116 produced using cirrhosis forecast model 112, and accuracy evaluation data 124 provided by system user 140.

It is noted that although FIG. 1 depicts cirrhosis forecast model 112 and software code 110 for training cirrhosis forecast model 112 as being mutually co-located in system memory 106, that representation is merely provided as an aid to conceptual clarity. More generally, system 100 may include one or more computing platforms 102, such as computer servers for example, which may be co-located, or may form an interactively linked but distributed system, such as a cloud based system, for instance. As a result, hardware processor 104 and system memory 106 may correspond to distributed processor and memory resources within system 100. Thus, it is to be understood that cirrhosis forecast model 112 and software code 110 for training cirrhosis forecast model 112 may be stored remotely from one another within the distributed memory resources of system 100.

According to the implementation shown in FIG. 1, system user 140 may utilize client system 130 to interact with computing platform 102 over communication network 120. System user 140 may utilize client system 130 to access software code 110 and cirrhosis forecast model 112 remotely, or to download software code 110 and cirrhosis forecast model 112 to client system 130. In one implementation, computing platform 102 may correspond to one or more web servers, accessible over a packet-switched network such as the Internet, for example. Alternatively, computing platform 102 may correspond to one or more servers supporting a local area communication network (LAN), or included in another type of limited distribution network.

Although client system 130 is shown as a personal computer (PC) in FIG. 1, that representation is also provided merely as an example. In other implementations, client system 130 may be any other suitable mobile or stationary computing device or system. For example, in other implementations, client system 130 may take the form of a laptop computer, tablet computer, or smartphone, for example.

It is noted that, in various implementations, cirrhosis forecast model 112 and/or cirrhosis prediction 116 when generated and/or produced using software code 110, may be stored in system memory 106 and/or may be copied to non-volatile storage (not shown in FIG. 1). Alternatively, or in addition, as shown in FIG. 1, in some implementations, cirrhosis prediction 116 may be sent to client system 130 having display 138, for example by being transferred via network communication links 122 of communication network 120. It is further noted that display 138 may take the form of a liquid crystal display (LCD), a light-emitting diode (LED) display, an organic light-emitting diode (OLED) display, or another suitable display screen that performs a physical transformation of signals to light.

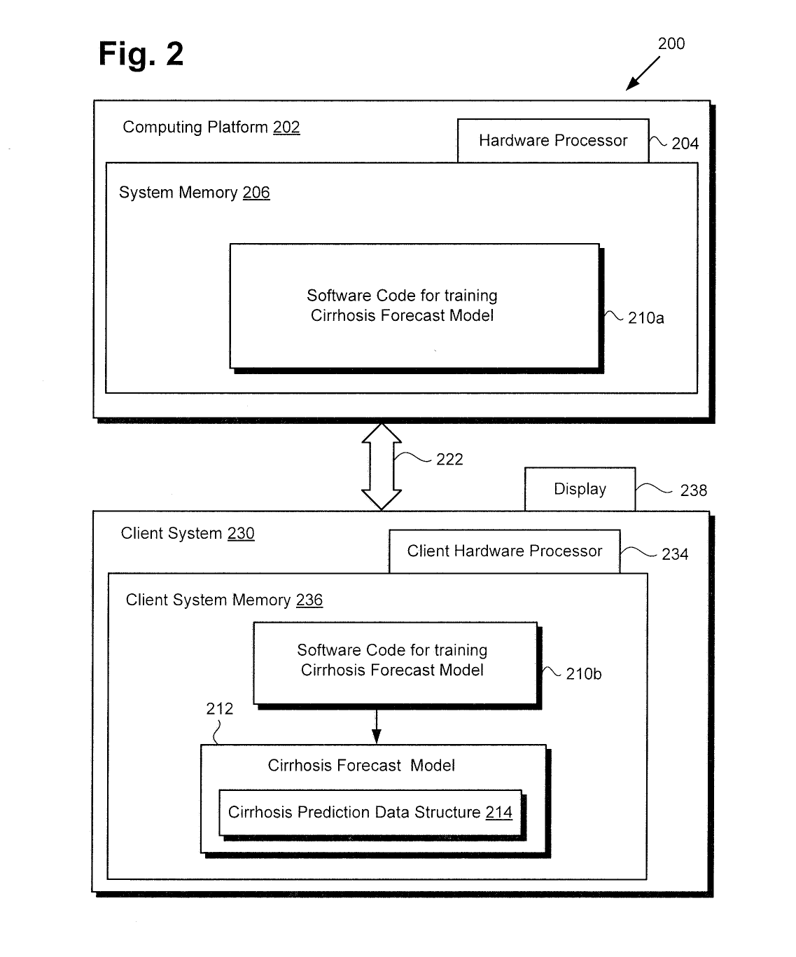

FIG. 2 shows an exemplary implementation of system 200 in combination with a more detailed representation of client system 230. System 200 includes computing platform 202, which is shown to be interactively connected to client system 230 over network communication link 222. Computing platform 202 includes hardware processor 204, and system memory 206 storing software code 210a for training a cirrhosis forecast model. As shown in FIG. 2, client system 230 includes client hardware processor 234, display 238, and client system memory 236 storing cirrhosis forecast model 212 and software code 210b for training cirrhosis forecast model 212. Also shown in FIG. 2 is cirrhosis prediction data structure 214.

Network communication link 222, and system 200 including computing platform 202 having hardware processor 204 and system memory 206 correspond in general to network communication link 122, and system 100 including computing platform 102 having hardware processor 104 and system memory 106, in FIG. 1, and those corresponding features may share any of the characteristics attributed to either corresponding feature by the present disclosure. In addition, software code 210a, in FIG. 2, corresponds in general to software code 110, in FIG. 1, and those corresponding features may share any of the characteristics attributed to either corresponding feature by the present disclosure.

Client system 230 and display 238 correspond respectively in general to client system 130 and display 138, in FIG. 1, and those corresponding features may share any of the characteristics attributed to either corresponding feature by the present disclosure. Moreover, software code 210b corresponds in general to software code 110/210a, while cirrhosis forecast model 212 and cirrhosis prediction data structure 214 correspond respectively in general to cirrhosis forecast model 112 and cirrhosis prediction data structure 114, in FIG. 1. As a result, software code 210b, cirrhosis forecast model 212, and cirrhosis prediction data structure 214 may share any of the characteristics attributed to corresponding software code 110/210a, cirrhosis forecast model 212, and cirrhosis prediction data structure 214 by the present disclosure.

According to the exemplary implementation shown in FIG. 2, software code 210b is located in client system memory 236, having been received from computing platform 202 via network communication link 222. In one implementation, network communication link 222 corresponds to transfer of software code 210b over a packet-switched network, for example. Once transferred, for instance by being downloaded over network communication link 222, software code 210b may be persistently stored in client system memory 236 and may be executed locally on client system 230 by client hardware processor 234.

Client hardware processor 234 may be the central processing unit (CPU) for client system 230, for example, in which role client hardware processor 234 runs the operating system for client system 230 and executes software code 210b. In the exemplary implementation of FIG. 2, a user of client system 230, such as system user 140, in FIG. 1, can utilize software code 210b on client system 230 to generate and/or train cirrhosis forecast model 212. Thus, according to the exemplary implementation shown in FIG. 2, client system 230 may function analogously to system 100/200 and, like system 100/200, may be utilized to forecast cirrhosis in one or more human subjects.

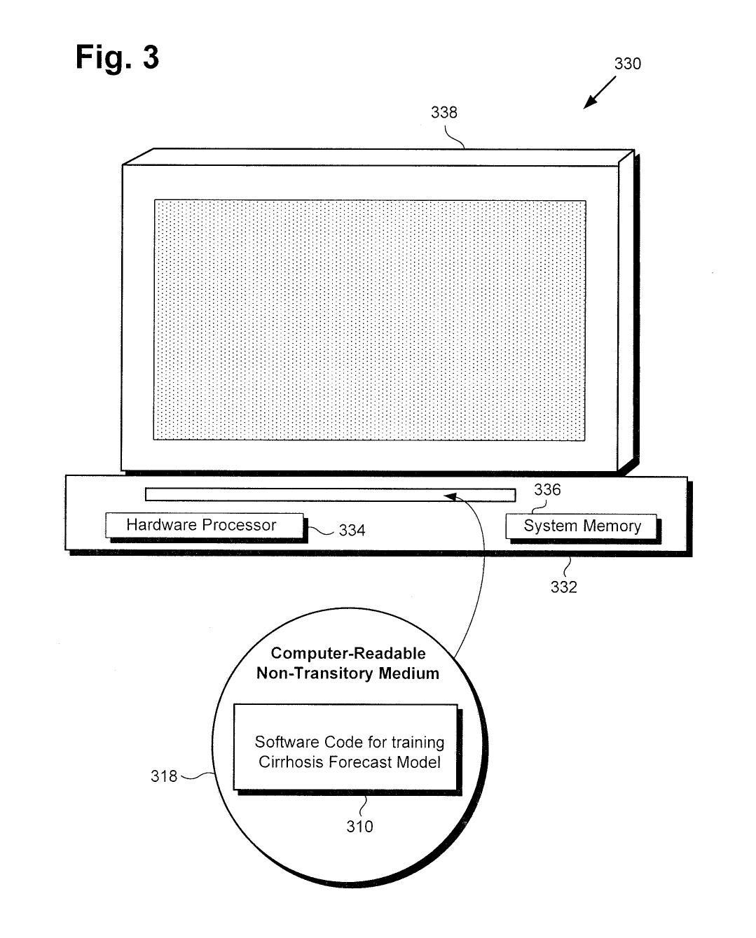

FIG. 3 shows an exemplary system and a computer-readable non-transitory medium including instructions for training a cirrhosis forecast model, according to one implementation. System 330, in FIG. 3, includes computer 332 having hardware processor 334 and system memory 336, interactively linked to display 338. Display 338 may take the form of an LCD, LED display, an OLED display, or another suitable display screen that performs a physical transformation of signals to light. System 330 including display 338, and computer 332 having hardware processor 334 and system memory 336 corresponds in general to any or all of systems 100/130/200/230, in FIG. 1/2, and those corresponding features may share the characteristics attributed to any corresponding feature by the present disclosure.

Also shown in FIG. 3 is computer-readable non-transitory medium 318 having software code 310 for training a cirrhosis forecast model stored thereon. The expression “computer-readable non-transitory medium,” as used in the present application, refers to any medium, excluding a carrier wave or other transitory signal, that provides instructions to hardware processor 334 of computer 332. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory media include, for example, optical discs, RAM, programmable read-only memory (PROM), erasable PROM (EPROM), and FLASH memory.

According to the implementation shown in FIG. 3, computer-readable non-transitory medium 318 provides software code 310 for execution by hardware processor 334 of computer 332. Software code 310 for training a cirrhosis forecast model corresponds in general to software code 110/210a/210b, in FIG. 1/2, and is capable of performing all of the operations attributed to those corresponding features by the present disclosure. In other words, software code 310 may be used to generate a cirrhoses forecast model corresponding to cirrhosis forecast model 112/212, and/or to train the cirrhosis forecast model based on a cirrhosis prediction and/or an accuracy evaluation data corresponding respectively to cirrhosis prediction 116 and accuracy evaluation data 124.

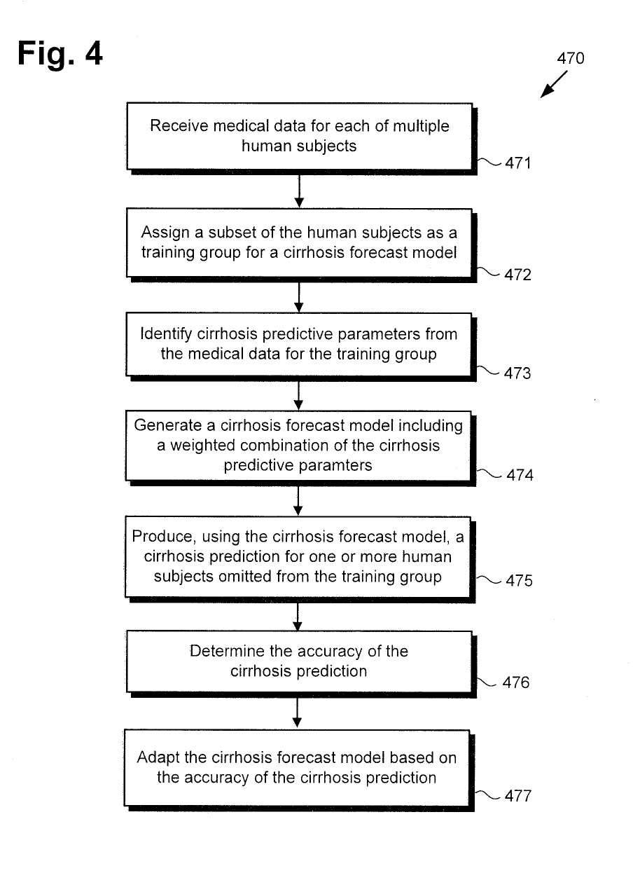

The systems for training a cirrhosis forecast model discussed above by reference to FIGS. 1, 2, and 3, will be further described below with reference to FIG. 4. FIG. 4 presents flowchart 470 outlining an exemplary method for use by a system for training a cirrhosis forecast model. With respect to the method outlined in FIG. 4, it is noted that certain details and features have been left out of flowchart 470 in order not to obscure the discussion of the inventive features in the present application.

Referring to FIG. 4 in combination with FIGS. 1, 2, and 3, flowchart 470 begins with receiving medical data 160 for each of multiple human subjects (action 471). Medical data 160 may be received by software code 110/210a/210b/310 of system 100/130/200/230/330, executed by hardware processor 104/204/234/334. As shown in FIG. 1, medical data 160 may be received by software code 110/210a/210b/310 from medical data aggregator 150, via communication network 120 and network communication links 122/222. Medical data 160 may include data providing a medical profile of individual subjects among cirrhotic subject population 152 and non-cirrhotic subject population 154.

For example, medical data 160 may include the age, gender, race, general health, history of alcohol use, and genotype of subjects among cirrhotic subject population 152 and non-cirrhotic subject population 154, as well as the results of specific tests performed on those subjects. In addition, medical data 160 can include any other characteristics considered to be relevant to the development of cirrhosis, as well as whether or not a specific subject has been diagnosed as presently cirrhotic or non-cirrhotic. However, it is emphasized that medical data 160 omits any personally identifiable information (PII) of subjects among cirrhotic subject population 152 and non-cirrhotic subject population 154. As a result, all subjects among cirrhotic subject population 152 and non-cirrhotic subject population 154 used to generate and/or train cirrhosis forecast model 112/212 remain anonymous.

Flowchart 470 continues with assigning a subset of subjects among cirrhotic subject population 152 and/or non-cirrhotic subject population 154 as a training group for cirrhosis forecast model 112/212 (action 472). In some implementations, the training group may include subjects from both cirrhotic subject population 152 and non-cirrhotic subject population 154. That is to say, in some implementations, the training group may include cirrhotic subjects and non-cirrhotic subjects. Moreover, in some implementations, the training group may be randomly assigned from cirrhotic subject population 152 and/or non-cirrhotic subject population 154.

According to one exemplary implementation, the training group may include all of the subjects included in cirrhotic subject population 152 and/or non-cirrhotic subject population 154 except one subject. That one omitted subject may subsequently be used as a test subject to test the accuracy of cirrhosis forecast model 112/212. Assigning the subset of subjects among cirrhotic subject population 152 and/or non-cirrhotic subject population 154 as a training group for cirrhosis forecast model 112/212 may be performed by software code 110/210a/210b/310 of system 100/130/200/230/330, executed by hardware processor 104/204/234/334.

Flowchart 470 continues with identifying cirrhosis predictive parameters from medical data 160 for the training group (action 473). Medical data 160 for the training group may include many candidate parameters for use in forecasting cirrhosis, such as dozens, or even hundreds of candidate parameters, for example. In some implementations, action 473 may include determining the cirrhosis predictive parameters through analysis of medical data 160. In those implementations, identification of the cirrhosis predictive parameters from among the dozens or hundreds of candidate parameters provided by medical data 160 may be performed using any suitable statistical technique known in the art, such as receiver operating characteristic (ROC) analysis, for example.

In other implementations, however, the cirrhosis predictive parameters may be predetermined, and action 473 may include extracting those predetermined cirrhosis predictive parameters from medical data 160 for the training group. Identification of the cirrhosis predictive parameters may be performed by software code 110/210a/210b/310 of system 100/130/200/230/330, executed by hardware processor 104/204/234/334. For example, in one implementation, the following parameters may be identified as cirrhosis predictive parameters (pᵢ) for use in training cirrhosis forecast model 112/212:
p₁=Gender
p₂=Fibrosis Stage
p₃=Race
p₄=APRI (Aspartate Aminotranferase to Platelet Ratio Index) Score
p₅=Consumption of Alcohol
p₆=HIV (Human Immunodeficiency Virus) Status
p₇=MELD (Model for End-Stage Liver Disease) Score
p₈=Status of Renal Failure

Flowchart 470 continues with generating cirrhosis forecast model 112/212 including a weighted combination of the cirrhosis predictive parameters (action 474). As shown in FIGS. 1 and 2, cirrhosis forecast model 112/212 includes cirrhosis prediction data structure 114/214. Thus, generating cirrhosis forecast model 112/212 includes generating cirrhosis prediction data structure 114/214. Cirrhosis prediction data structure 114/214 includes weighting factors for each of the cirrhosis predictive parameters (pᵢ) identified in action 473. The values of those weighting factors are determined through initial training of cirrhosis forecast model 112/212 using the training group assigned in action 472. Initial training of cirrhosis forecast model 112/212 may be performed by software code 110/210a/210b/310, executed by hardware processor 104/204/234/334, and using logistic regression, for example.

As an example, cirrhosis prediction data structure 114/214 of initially trained cirrhosis forecast model 112/212 may include the following expression for the probability that cirrhosis is present or substantially imminent for a subject:

$$\begin{matrix}Cirrhosis Probability = 1 / ( 1 + {e}^{- K} ) & ( Equation 1 ) \\ With \text{:} K = C + {\sum }_{1}^{N} {w}_{i} {p}_{i} & ( Equation 2 )\end{matrix}$$

Where C is a constant, the pᵢ are the cirrhosis predictive parameters identified in action 473, and the wᵢ are their respective weighting factors determined using logistic regression.

As an even more specific example, when the exemplary parameters listed above on page 15 of the present application are a complete set of cirrhosis predictive parameters, K may take the form:

K=C+w₁p₁+w₂p₂+w₃p₃+w₄p₄+w₅p₅+w₆p₆+w₇p₇w₈p₈

Flowchart 470 continues with producing, using cirrhosis forecast model 112/212, cirrhosis prediction 116 for one or more subjects omitted from the training group (action 475). As noted above, a subset of subjects from cirrhotic subject population 152 and/or non-cirrhotic subject population 154 are assigned to a training group for cirrhosis forecast model 112/212 in action 472. Those subjects not assigned to the training group may be used as a testing group for cirrhosis forecast model 112/212.

As further noted above, in one exemplary implementation, the training group may include all of the subjects included in cirrhotic subject population 152 and/or non-cirrhotic subject population 154 except one subject. Consequently, in that implementation, cirrhosis forecast model 112/212 may be tested using the one subject omitted from the training group. Cirrhosis prediction 116 may be produced by software code 110/210a/210b/310 of system 100/130/200/230/330, executed by hardware processor 104/204/234/334, and using cirrhosis forecast model 112/212 including cirrhosis prediction data structure 114/214.

Flowchart 470 continues with determining the accuracy of cirrhosis prediction 116 (action 476). In some implementations, the accuracy of cirrhosis prediction 116 may be determined through comparison of cirrhosis prediction 116 with medical data 160, which may include the cirrhosis status of the one or more subjects on which cirrhosis forecast model is tested in action 475. However, in other implementations, cirrhosis prediction 116 may be displayed to system user 140 for review and evaluation. For example, in those implementations, cirrhosis prediction 116 may be displayed to system user 140 through use of display 138/238/338. Moreover, in those implementations, system user 140 may provide accuracy evaluation data 124 rating the accuracy of cirrhosis prediction 116.

Consequently, in some implementations, determining the accuracy of cirrhosis prediction 116 may include receiving accuracy evaluation data 124 from system user 140. It is noted that accuracy evaluation data 124 may be received by system 130/230/330 as a direct input from system user 140. Alternatively, in some implementations, accuracy evaluation data 124 may be received by system 100/200 via communication network 120 and network communication links 122/222. The accuracy of cirrhosis prediction 116 may be determined by software code 110/210a/210b/310 of system 100/130/200/230/330, executed by hardware processor 104/204/234/334.

Flowchart 470 can conclude with adapting cirrhosis forecast model 112/212 based on the accuracy of cirrhosis prediction 116 (action 477). For example, software code 110/210a/210b/310 may be configured to engage in machine learning to adapt cirrhosis prediction data structure 114/214 in response to accuracy evaluation data 124 and/or its own determination of the accuracy of cirrhosis prediction 116. In some implementations, for example, cirrhosis prediction data structure 114/214, and thus cirrhosis forecast model 112/214 may be adapted by modifying one or more of the weighting factors wᵢ appearing in Equation 2, above. That is to say, cirrhosis prediction data structure 114/214 may be an adaptive data structure. Cirrhosis forecast model 112/212 including cirrhosis prediction data structure 114/214 may be adapted by software code 110/210a/210b/310 of system 100/130/200/230/330, executed by hardware processor 104/204/234/334.

Thus, the systems and methods disclosed in the present application address serious financial and ethical dilemmas posed by decisions to permit or deny patient access to extremely costly but highly therapeutic specialty drug treatments for hepatitis C. By forecasting the likelihood that a patient having hepatitis C will develop cirrhosis, the disclosed systems and methods may be used to advantageously identify those patients who might benefit most from specialty drug treatment. Consequently, the systems and methods disclosed in the present application can play an important role in enabling seriously and/or chronically ill patients to have greater access to necessary treatments, thereby improving clinical outcomes for insurers, healthcare providers, and patients alike.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system for training a cirrhosis forecast model, the system comprising:
a computing platform including a hardware processor and a memory;
a software code for training the cirrhosis forecast model stored in the memory; and
the hardware processor configured to execute the software code to:
receive a medical data for each of a plurality of human subjects;
assign a subset of the human subjects as a training group for the cirrhosis forecast model;
identify a plurality of cirrhosis predictive parameters from the medical data for the training group;
generate a cirrhosis forecast model including a weighted combination of the cirrhosis predictive parameters;
produce, using the cirrhosis forecast model, a cirrhosis prediction for at least one of the human subjects omitted from the training group;
determine an accuracy of the cirrhosis prediction; and
adapt the cirrhosis forecast model based on the accuracy of the cirrhosis prediction.

2. The system of claim 1, wherein the hardware processor is further configured to execute the software code to adapt the cirrhosis forecast model by modifying at least one of a plurality of weighting factors included in the weighted combination of the cirrhosis predictive parameters.

3. The system of claim 1, wherein the hardware processor is further configured to execute the software code to display the cirrhosis prediction to a system user.

4. The system of claim 3, wherein the hardware processor is further configured to execute the software code to determine the accuracy of the cirrhosis prediction by receiving an accuracy evaluation data from the system user.

5. The system of claim 1, wherein the training group includes cirrhotic subjects and non-cirrhotic subjects.

6. The system of claim 1, wherein the training group is randomly assigned.

7. The system of claim 1, wherein training group includes all of the plurality of human subjects except one.

8. A method for use by a system for training a cirrhosis forecast model, the system including a computing platform having a hardware processor and a memory storing a software code for training the cirrhosis forecast model, the method comprising:
receiving, using the hardware processor, a medical data for each of a plurality of human subjects;
assigning, using the hardware processor, a subset of the human subjects as a training group for the cirrhosis forecast model;
identifying, using the hardware processor, a plurality of cirrhosis predictive parameters from the medical data for the training group;
generating, using the hardware processor, a cirrhosis forecast model including a weighted combination of the cirrhosis predictive parameters;
producing, using the hardware processor and the cirrhosis forecast model, a cirrhosis prediction for at least one of the human subjects omitted from the training group;
determining, using the hardware processor, an accuracy of the cirrhosis prediction; and
adapting, using the hardware processor, the cirrhosis forecast model based on the accuracy of the cirrhosis prediction.

9. The method of claim 8, wherein adapting the cirrhosis forecast model comprises modifying at least one of a plurality of weighting factors included in the weighted combination of the cirrhosis predictive parameters.

10. The method of claim 8, further comprising displaying the cirrhosis prediction to a system user.

11. The method of claim 10, wherein determining the accuracy of the cirrhosis prediction comprises receiving an accuracy evaluation data from the system user.

12. The method of claim 8, wherein the training group includes cirrhotic subjects and non-cirrhotic subjects.

13. The method of claim 8, wherein the training group is randomly assigned.

14. The method of claim 8, wherein training group includes all of the plurality of human subjects except one.

15. A computer-readable non-transitory medium having stored thereon instructions, which when executed by a hardware processor, perform a method comprising:
receiving a medical data for each of a plurality of human subjects;
assigning a subset of the human subjects as a training group for the cirrhosis forecast model;
identifying a plurality of cirrhosis predictive parameters from the medical data for the training group;
generating a cirrhosis forecast model including a weighted combination of the cirrhosis predictive parameters;
producing, using the cirrhosis forecast model, a cirrhosis prediction for at least one of the human subjects omitted from the training group;
determining an accuracy of the cirrhosis prediction; and
adapting the cirrhosis forecast model based on the accuracy of the cirrhosis prediction.

16. The computer-readable non-transitory medium of claim 15, wherein adapting the cirrhosis forecast model comprises modifying at least one of a plurality of weighting factors included in the weighted combination of the cirrhosis predictive parameters.

17. The computer-readable non-transitory medium of claim 15, wherein the method further comprises displaying the cirrhosis prediction to a system user.

18. The computer-readable non-transitory medium of claim 17, wherein determining the accuracy of the cirrhosis prediction comprises receiving an accuracy evaluation data from the system user.

19. The computer-readable non-transitory medium of claim 15, wherein the training group is randomly assigned.

20. The computer-readable non-transitory medium of claim 15, wherein training group includes all of the plurality of human subjects except one.
